(19) United States
(12) Patent Application Publication
(10) Pub. No.: US 2024/0076788 A1
(43) Pub. Date: Mar. 7, 2024

(54) ANODIC ELECTRODE, WATER ELECTROLYSIS DEVICE INCLUDING THE SAME AND METHOD FOR PREPARING THE SAME

(71) Applicant: KOREA INSTITUTE OF SCIENCE AND TECHNOLOGY, Seoul (KR)

(72) Inventors: Hyun S. PARK, Seoul (KR); Jong Hyun JANG, Seoul (KR); Hee-Young PARK, Seoul (KR); Su Ji LEE, Seoul (KR); Sung Jong YOO, Seoul (KR); Jin Young KIM, Seoul (KR); Jimin KONG, Seoul (KR); Jin-ho OH, Seoul (KR); So Young LEE, Seoul (KR)

(21) Appl. No.: 18/156,277

(22) Filed: Jan. 18, 2023

(30) Foreign Application Priority Data
Sep. 1, 2022 (KR) 1020220110477

(51) Int. Cl. C25B 11/091; C25B 1/04; C25B 11/056; C25B 11/063

(52) U.S. Cl. CPC C25B 11/091; C25B 1/04; C25B 11/056; C25B 11/063

(57) ABSTRACT

Disclosed are an oxidizing electrode, a water electrolysis device including the same and a method for manufacturing the same. According to exemplary embodiments of the present disclosure, there is provided an oxidizing electrode with improved performance at low loadings of noble metals, especially, ruthenium (Ru) and iridium oxide, in which a ruthenium (Ru) layer and an iridium oxide layer formed on a substrate by electrodeposition in a sequential order are supported by electrochemical reaction rather than physical bonding.

### CROSS-REFERENCE TO RELATED APPLICATION

This application claims priority to Korean Patent Application No. 10-2022-0110477, filed on Sep. 1, 2022, and all the benefits accruing therefrom under 35 U.S.C. § 119, the contents of which in its entirety are herein incorporated by reference.

### TECHNICAL FIELD

This invention was made with the support of the Ministry of Science and ICT under Project No. 1711173294, which was conducted under the research project entitled “Development of Green Hydrogen Production-Liquid Storage Integrated Technology” within the project named “Support for research and operation expenses of the Korea Institute of Science and Technology” under the management of the Korea Institute of Science and Technology, from Jan. 1, 2022 to Dec. 31, 2022.

This invention was made with the support of the Ministry of Science and ICT under Project No. 1711159906, which was conducted under the research project entitled “Development of multi-component/thin-layer non-Pt precious metal electrocatalysts towards HER and water electrolysis electrodes/MEAs through optimizations of adsorption strength and mass transport” within the project named “Nano-Material Technology Development (R & D)” under the management of the National Research Foundation of Korea, from Jan. 1, 2022 to Dec. 31, 2022.

This invention was made with the support of the Ministry of Trade, Industry and Energy under Project No. 1415180391, which was conducted under the research project entitled “Development of high performance catalytic electrodes and parts technology on 2.5 kW class AEM water electrolysis using waste alkali solution for hydrogen production” within the project named “Materials/Parts Technology Development” under the management of the Korea Evaluation Institute Of Industrial Technology, from Apr. 1, 2022 to Dec. 31, 2022.

This invention was made with the support of the Ministry of Trade, Industry and Energy under Project No. 1415181329, which was conducted under the research project entitled “Development of Robust Polymer Electrolyte Membrane and Multiscale Interface Control for High Efficiency PEM Electrolysis” within the project named “New Renewable Energy Core Technology Development” under the management of the Korea Energy Technology Evaluation and Planning, from Apr. 1, 2022 to Dec. 31, 2022.

This invention was made with the support of the Ministry of Science and ICT under Project No. 1055000979, which was conducted under the research project entitled “Development of large-scale aqueous ammonia electrolysis system for high-efficiency hydrogen extraction” within the project named “Hydrogen Energy Innovation Technology Development Program” under the management of the National Research Foundation of Korea, from Jul. 1, 2022 to Dec. 31, 2022.

The present disclosure relates to an oxidizing electrode, a water electrolysis device including the same and a method for manufacturing the same, and more particularly, to an oxidizing electrode having a ruthenium (Ru) layer and an iridium oxide layer formed on a substrate by electrodeposition in a sequential order, a water electrolysis device including the same and a method for manufacturing the same.

### BACKGROUND ART

To replace fossil energy, as hydrogen, clean energy, is used in energy applications, various types of water electrolysis systems are being developed. The water electrolysis technology may be largely divided into alkaline water electrolysis and proton exchange membrane water electrolysis. The proton exchange membrane water electrolysis has high driving pressure/high current density and high purity of hydrogen produced, but requires a very large amount of noble metals to manufacture electrodes. In particular, a solid polymer water electrolysis cell uses a membrane electrode assembly (MEA) in which a solid polymer electrolyte membrane made of a polymer material is coated with an anode and a cathode on two sides thereof, and thus it is very safe, can operate at low temperature and is very efficient compared to the alkaline water electrolysis.

However, currently, the proton exchange membrane water electrolysis requires very high system costs since it requires a very large amount of noble metal catalysts to manufacture electrodes, and due to the slow kinetics of the oxygen evolution reaction during water electrolysis driving at the oxidizing electrode, a very large amount of noble metal catalysts has been used. Many studies have been made to reduce the amount of noble metal catalysts, and Korean Patent Publication No. 10-2019-0046074 discloses an oxidizing electrode including a double deposited catalyst, a water electrolysis device including the same, a regenerative fuel cell and a method for manufacturing the oxidizing electrode. However, since platinum is so costly, its alternative is necessary.

### DISCLOSURE

### Technical Problem

The present disclosure is directed to providing an oxidizing electrode with improved performance at low loadings of ruthenium (Ru) and iridium oxide, and more particularly, an oxidizing electrode having a ruthenium (Ru) layer and an iridium oxide layer formed on a substrate by electrodeposition in a sequential order, and a method for manufacturing a water electrolysis device including the same.

### Technical Solution

In an aspect, in exemplary embodiments of the present disclosure, there is provided an oxidizing electrode including a substrate; a ruthenium (Ru) layer formed on the substrate by electrodeposition; and an iridium oxide layer formed on the ruthenium (Ru) layer by electrodeposition.

In an aspect, in exemplary embodiments of the present disclosure, there is provided a water electrolysis device including the oxidizing electrode.

In an aspect, in exemplary embodiments of the present disclosure, there is provided a method for manufacturing the oxidizing electrode including forming the ruthenium (Ru) layer on the substrate by electrodeposition; and forming the iridium oxide layer on the ruthenium (Ru) layer by electrodeposition.

### Advantageous Effects

According to exemplary embodiments of the present disclosure, it is possible to provide the oxidizing electrode with improved performance at low loadings of noble metals, especially, ruthenium (Ru) and iridium oxide, in which the ruthenium (Ru) layer and the iridium oxide layer formed on the substrate by electrodeposition in a sequential order are supported by electrochemical reaction rather than physical bonding.

### DESCRIPTION OF DRAWINGS

FIGS. 1A, 1B, and 1C are field emission scanning electron microscopy (FE-SEM) images of the observed surface of an oxidizing electrode according to an embodiment of the present disclosure.

FIGS. 2A, 2B, and 2C are graphs showing a cyclic voltammetry (CV) curve of an oxidizing electrode according to an embodiment of the present disclosure.

FIG. 2D is a graph showing the electrochemical surface area (ECSA) of an oxidizing electrode according to an embodiment of the present disclosure.

FIGS. 3A, 3B, 3C, 3D, 3E, and 3F are FE-SEM images of the observed surface of an oxidizing electrode according to an embodiment of the present disclosure.

FIGS. 4A, 4B, and 4C are high resolution transmission electron microscopy (HR-TEM) images of the observed surface of an oxidizing electrode according to an embodiment of the present disclosure.

FIGS. 5A and 5B are graphs showing an I-V polarization curve of an oxidizing electrode according to an embodiment of the present disclosure.

FIG. 6 is a graph showing the mass activity evaluation results of an oxidizing electrode according to an embodiment of the present disclosure.

FIGS. 7A and 7B are graphs showing an I-V polarization curve of an oxidizing electrode according to an embodiment of the present disclosure.

FIGS. 8A and 8B are graphs showing the stability evaluation results of an oxidizing electrode according to an embodiment of the present disclosure.

FIG. 9 is a graph showing the durability evaluation results of an oxidizing electrode according to an embodiment of the present disclosure.

FIG. 10 is a graph showing an I-V polarization curve of an oxidizing electrode according to an embodiment of the present disclosure.

FIG. 11 is a graph showing the high-frequency resistance (HFR) of an oxidizing electrode according to an embodiment of the present disclosure.

FIGS. 12A and 12B are graphs showing the X-ray photoelectron spectroscopy (XPS) analysis results of an oxidizing electrode according to an embodiment of the present disclosure.

FIG. 13 is a graph showing the mass activity evaluation results of an oxidizing electrode according to an embodiment of the present disclosure.

FIGS. 14A, 14B, and 14C are graphs showing the durability evaluation results of an oxidizing electrode according to an embodiment of the present disclosure.

FIGS. 15A, 15B and 15C are graphs showing the cell performance, HFR and degradation rate of an oxidizing electrode according to an embodiment of the present disclosure.

FIGS. 16A, 16B, 16C, and 16D are energy dispersive spectroscopy (EDS) images of the observed atomic ratio of an oxidizing electrode according to an embodiment of the present disclosure.

FIGS. 17A and 17B are graphs showing the XPS analysis results of an oxidizing electrode according to an embodiment of the present disclosure.

FIGS. 18A and 18B are graphs showing a CV curve of an oxidizing electrode according to an embodiment of the present disclosure.

### BEST MODE

The terms as used herein are general terms selected as those being now used as widely as possible in consideration of functions in the present disclosure, but they may differ depending on the intention of those skilled in the art or the convention or the emergence of new technology. Additionally, in certain cases, there may be terms arbitrarily selected by the applicant, and in this case, the meaning will be described in the corresponding description part of the specification. Accordingly, the terms as used herein should be defined based on the meaning of the terms and the context throughout the specification, rather than simply the name of the terms.

Unless otherwise defined, all terms used herein including technical and scientific terms have the same meaning as commonly understood by one of ordinary skill in the art. The commonly understood terms should be interpreted as having a meaning that is consistent with their meaning in the context of the relevant art, and will not be interpreted in an idealized or overly formal sense unless expressly so defined herein.

The numerical range includes numerical values defined herein. It should be understood that every maximum numerical limitation given throughout the specification includes every lower numerical limitation as if such lower numerical limitations are expressly written herein. Every minimum numerical limitation given throughout the specification includes every higher numerical limitation as if such higher numerical limitations are expressly written herein. Every numerical range given throughout the specification includes every narrower numerical range that falls within broader numerical range as if such narrower numerical ranges are all expressly written herein.

The terms “comprising”, “including” and “containing” as used herein are generic or open-ended terms, and do not preclude the presence or addition of other elements or method steps. The phrase “or a combination thereof” as used herein refers to all sequences and combinations of items numerated before the phrase. For example, “A, B, C, or a combination thereof” is intended to include A, B, C, AB, AC, BC or ABC, and where the order is important in specific contexts, at least one of BA, CA, CB, CBA, BCA, ACB, BAC or CAB. Along with this example, it may include combinations containing repetition(s) of at least one item or term, for example, BB, AAA, MB, BBC, AAABCCCC, CBBAAA, CABABB, or the like. Those skilled in the art will understand that there is no specific limit to the number of items or terms in any combination unless the context clearly indicates otherwise.

Hereinafter, exemplary embodiments of the present disclosure will be described in detail with reference to the accompanying drawings. However, it is obvious that the present disclosure is not limited by the following embodiments.

Oxidizing Electrode

In an aspect, exemplary embodiments of the present disclosure provide an oxidizing electrode including a substrate; a ruthenium (Ru) layer formed on the substrate by electrodeposition; and an iridium oxide layer formed on the ruthenium (Ru) layer by electrodeposition.

Physical coating techniques have been used to form catalyst layers on substrates, for example, decal, brush printing, screen printing and spraying, and especially, the spraying technique has been commonly used, but in this case, since a very large amount of noble metal catalysts is used, there are losses of large amounts of noble metal catalysts.

In contrast, the inventors have used the electrodeposition technique considering the electrochemical activity when forming catalyst layers of oxidizing electrodes, and more specifically, they have manufactured an oxidizing electrode by electrodeposition of an oxygen evolution catalyst on an electrodeposited oxygen reduction catalyst. Through this, they have formed catalyst layers chemically bonded to each other at low loadings of ruthenium (Ru) and iridium oxide and developed water electrolysis technology with improved performance by the synergistic effect.

Specifically, the oxidizing electrode of the present disclosure uses the electrodeposition by electrochemical reaction, not physical coating with the substrate such as the spraying technique in the process of forming the catalyst layer on the substrate, and thus it contributes to the reduced contact resistance, it is possible to coat the thin catalyst layer at nanometer scale on the substrate during the electrodeposition, and reduce the loss of the catalyst activity area, leading to high catalyst activity at low loading, and it is easy to control the catalyst loading according to the deposition conditions.

The ruthenium (Ru) layer may be formed by the deposition of ruthenium (Ru) particles on the substrate. The ruthenium (Ru) layer is formed on the substrate by the electrodeposition to prevent the exposure of the substrate material. The ruthenium (Ru) has higher durability than non-noble metals, and is the most inexpensive material among the platinum group elements. The ruthenium (Ru) may act as a support of the iridium oxide.

According to an embodiment of the present disclosure, the ruthenium (Ru) layer is deposited in the form of a film, and the thickness of the film is 140 to 154 nm. As the ruthenium (Ru) layer is deposited in the form of a film, it is possible to increase the electrochemically active surface of the oxidizing electrode and the surface area of the iridium oxide layer. More specifically, the thickness of the film may be 140 nm or more, 141 nm or more, 142 nm or more, 143 nm or more, 144 nm or more, 145 nm or more, 146 nm or more, 147 nm or more; 154 nm or less, 153 nm or less, 152 nm or less, 151 nm or less, 150 nm or less, 149 nm or less, 148 nm or less, or 147 nm or less, but is not limited thereto.

The formula of the iridium oxide may be IrOx, and the x may be 1.5 to 2.5. The iridium oxide layer is formed on the ruthenium (Ru) layer by the electrodeposition to prevent the exposure of the ruthenium (Ru) layer.

According to an embodiment of the present disclosure, the thickness of the iridium oxide layer is 140 to 160 nm. The electrodeposition makes it possible to coat the thin iridium oxide layer at nanometer scale on the substrate and achieve uniform thickness coating. More specifically, the thickness of the iridium oxide layer may be 140 nm or more, 141 nm or more, 142 nm or more, 143 nm or more, 144 nm or more, 145 nm or more, 146 nm or more, 147 nm or more, 148 nm or more, 149 nm or more, 150 nm or more; 160 nm or less, 159 nm or less, 158 nm or less, 157 nm or less, 156 nm or less, 155 nm or less, 154 nm or less, 153 nm or less, 152 nm or less, 151 nm or less, or 150 nm or less, but is not limited thereto.

According to an embodiment of the present disclosure, the specific surface area of the iridium oxide layer is 11 to 12 m²/g. More specifically, the specific surface area of the iridium oxide layer may be 11 m²/g or more, 11.1 m²/g or more, 11.2 m²/g or more, 11.3 m²/g or more, 11.4 m²/g or more, 11.5 m²/g or more; 12 m²/g or less, 11.9 m²/g or less, 11.8 m²/g or less, 11.7 m²/g or less, 11.6 m²/g or less, or 11.5 m²/g or less, but is not limited thereto.

According to an embodiment of the present disclosure, the weight of the ruthenium (Ru) layer per unit area of the oxidizing electrode is 0.01 to 0.06 mg/cm². More specifically, the weight of the ruthenium (Ru) layer may be 0.01 mg/cm² or more, 0.012 mg/cm² or more, 0.014 mg/cm² or more, 0.016 mg/cm² or more, 0.018 mg/cm² or more, 0.02 mg/cm² or more, 0.022 mg/cm² or more, 0.024 mg/cm² or more, 0.026 mg/cm² or more, 0.028 mg/cm² or more, 0.03 mg/cm² or more, 0.032 mg/cm² or more, 0.034 mg/cm² or more, 0.036 mg/cm² or more, 0.038 mg/cm² or more, 0.04 mg/cm² or more, 0.042 mg/cm² or more, 0.044 mg/cm² or more, 0.0446 mg/cm² or more; 0.06 mg/cm² or less, 0.058 mg/cm² or less, 0.056 mg/cm² or less, 0.054 mg/cm² or less, 0.052 mg/cm² or less, 0.05 mg/cm² or less, 0.048 mg/cm² or less, 0.046 mg/cm² or less, 0.0446 mg/cm² or less, or 0.044 mg/cm² or less, but is not limited thereto. When the weight of the ruthenium (Ru) layer exceeds the upper limit, there may be a decrease in catalyst activity per mass in the water electrolysis mode.

According to an embodiment of the present disclosure, the total weight of the ruthenium (Ru) layer and the iridium oxide layer per unit area of the oxidizing electrode is 0.05 to 0.11 mg/cm². More specifically, the total weight of the ruthenium (Ru) layer and the iridium oxide layer may be 0.05 mg/cm² or more, 0.055 mg/cm² or more, 0.06 mg/cm² or more, 0.065 mg/cm² or more, 0.07 mg/cm² or more, 0.075 mg/cm² or more, 0.08 mg/cm² or more, 0.085 mg/cm² or more, 0.09 mg/cm² or more, 0.095 mg/cm² or more, 0.1 mg/cm² or more, 0.105 mg/cm² or more, 0.105385 mg/cm² or more; 0.11 mg/cm² or less, 0.109 mg/cm² or less, 0.108 mg/cm² or less, 0.107 mg/cm² or less, 0.106 mg/cm² or less, or 0.105385 mg/cm² or less, but is not limited thereto. When the total weight of the ruthenium (Ru) layer and the iridium oxide layer exceeds the upper limit, there may be a decrease in catalyst activity per mass in the water electrolysis mode.

According to an embodiment of the present disclosure, the substrate is a titanium paper made of titanium fibers. The reported electrodes have the carbon corrosion problem due to the use of carbon materials for the substrate, but the present disclosure may increase the stability of the electrode by use of titanium.

Water Electrolysis Device

In an aspect, exemplary embodiments of the present disclosure provide a water electrolysis device including the oxidizing electrode. The exemplary embodiments of the present disclosure may provide a polymer electrolyte membrane water electrolysis (PEMWE) device including the oxidizing electrode.

A Method for Driving Water Electrolysis Device

In an aspect, exemplary embodiments of the present disclosure provide a method for driving the water electrolysis device, including applying, by a control unit, high current density and low current density to the water electrolysis device repeatedly in an alternating manner.

In general, bubbles are continuously generated during constant current driving of the water electrolysis device. The bubble blockage may cause catalyst dissociation, causing high local overpotential. In this instance, the bubbles in the catalyst layer can be removed by applying low current, but the low current degrades the performance of the oxidizing electrode. In this circumstance, the inventors found that the water electrolysis device achieves the optimal performance and durability in the driving conditions of driving at high current density and low current density repeatedly in an alternating manner, and based on the finding, completed the present disclosure. The inventors found that the switch operation can suppress the catalyst dissociation and reduce the overoxidation due to the large amount of remaining catalysts.

According to an embodiment of the present disclosure, the high current density is 1 to 5 A/cm², and the low current density is 0.01 to 0.5 A/cm². More specifically, the high current density may be 1 A/cm² or more, 1.1 A/cm² or more, 1.2 A/cm² or more, 1.3 A/cm² or more, 1.4 A/cm² or more, 1.5 A/cm² or more, 1.6 A/cm² or more, 1.7 A/cm² or more, 1.8 A/cm² or more, 1.9 A/cm² or more, 2 A/cm² or more; 5 A/cm² or less, 4.5 A/cm² or less, 4 A/cm² or less, 3.5 A/cm² or less, 3 A/cm² or less, 2.5 A/cm² or less, or 2 A/cm² or less, but is not limited thereto. More specifically, the low current density may be 0.01 A/cm² or more, 0.02 A/cm² or more, 0.03 A/cm² or more, 0.04 A/cm² or more, 0.05 A/cm² or more, 0.06 A/cm² or more, 0.07 A/cm² or more, 0.08 A/cm² or more, 0.09 A/cm² or more, 0.1 A/cm² or more; 0.5 A/cm² or less, 0.45 A/cm² or less, 0.4 A/cm² or less, 0.35 A/cm² or less, 0.3 A/cm² or less, 0.25 A/cm² or less, 0.2 A/cm² or less, 0.15 A/cm² or less, or 0.1 A/cm² or less, but is not limited thereto.

According to an embodiment of the present disclosure, the duration of application of the high current density is 1 to 8 hours, and the duration of application of the low current density is 1 to 10 hours. More specifically, the duration of application of the high current density may be 1 hour or more, 1.5 hours or more, 2 hours or more, 2.5 hours or more, 3 hours or more, 3.5 hours or more, 4 hours or more; 8 hours or less, 7.5 hours or less, 7 hours or less, 6.5 hours or less, 6 hours or less, 5.5 hours or less, 5 hours or less, 4.5 hours or less, or 4 hours or less, but is not limited thereto. More specifically, the duration of application of the low current density may be 1 hour or more, 1.5 hours or more, 2 hours or more, 2.5 hours or more, 3 hours or more, 3.5 hours or more, 4 hours or more, 4.5 hours or more, 5 hours or more, 5.5 hours or more, 6 hours or more; hours or less, 9.5 hours or less, 9 hours or less, 8.5 hours or less, 8 hours or less, 7.5 hours or less, 7 hours or less, 6.5 hours or less, or 6 hours or less, but is not limited thereto.

Method for Manufacturing Oxidizing Electrode

In an aspect, exemplary embodiments of the present disclosure provide a method for manufacturing the oxidizing electrode including forming the ruthenium (Ru) layer on the substrate by electrodeposition; and forming the iridium oxide layer on the ruthenium (Ru) layer by electrodeposition.

The spraying technique, one of the existing techniques, involves preparing a catalyst-containing slurry and spraying the slurry onto the substrate using a sonication spray gun, and does not consider the physical and chemical properties of materials, fails to coat a thin catalyst layer at nanometer scale on the substrate, and requires high loading to obtain high catalyst activity.

In contrast, the oxidizing electrode of the present disclosure uses the electrodeposition by electrochemical reaction, not physical coating with the substrate such as the spraying technique, to form the ruthenium (Ru) layer and the iridium oxide layer, and thus it contributes to the reduced contact resistance, it is possible to coat the thin catalyst layer at nanometer scale on the substrate during the electrodeposition, and reduce the loss of the catalyst activity area, leading to high catalyst activity at low loading, and is easy to control the catalyst loading according to the deposition conditions.

According to an embodiment of the present disclosure, in the step of forming the ruthenium (Ru) layer on the substrate by the electrodeposition, the electrodeposition is performed by direct current deposition following pulsed deposition.

The direct current deposition is a process of applying the direct current power at a predetermined voltage, and the pulsed deposition is a process of applying the pulsed direct current power repeatedly in a predetermined cycle.

In an embodiment, in the step of forming the ruthenium (Ru) layer on the substrate by the electrodeposition, the pulsed deposition may be performed at −500 mA (0.05 sec) and 200 mA (0.05 sec) for 120 cycles.

According to an embodiment of the present disclosure, in the step of forming the ruthenium (Ru) layer on the substrate by the electrodeposition, the direct current deposition following the pulsed deposition may be performed under the voltage of −3.0 to −1.0 V_{SCE}. More specifically, the direct current deposition voltage may be −3.0 V_{SCE} or more, −2.9 V_{SCE} or more, −2.8 V_{SCE} or more, −2.7 V_{SCE} or more, −2.6 V_{SCE} or more, −2.5 V_{SCE} or more; −1.0 V_{SCE} or less, −1.1 V_{SCE} or less, −1.2 V_{SCE} or less, −1.3 V_{SCE} or less, −1.4 V_{SCE} or less, −1.5 V_{SCE} or less, −1.6 V_{SCE} or less, −1.7 V_{SCE} or less, −1.8 V_{SCE} or less, −1.9 V_{SCE} or less, −2.0 V_{SCE} or less, −2.1 V_{SCE} or less, −2.2 V_{SCE} or less, −2.3 V_{SCE} or less, −2.4 V_{SCE} or less, or −2.5 V_{SCE} or less, but is not limited thereto. However, when the direct current deposition voltage exceeds the upper limit, hydrogen evolution reaction (HER) is highly active on the surface of the deposited ruthenium (Ru), thereby failing to form a uniform film.

According to an embodiment of the present disclosure, in the step of forming the ruthenium (Ru) layer on the substrate by the electrodeposition, the direct current deposition time following the pulsed deposition is 1 minute to 5 minutes. More specifically, the direct current deposition time may be 1 minute or more, 2 minutes or more; 10 minutes or less, 9 minutes or less, 8 minutes or less, 7 minutes or less, 6 minutes or less, 5 minutes or less, 4 minutes or less, 3 minutes or less, or 2 minutes or less, but is not limited thereto.

According to an embodiment of the present disclosure, in the step of forming the iridium oxide layer on the ruthenium (Ru) layer by the electrodeposition, the electrodeposition is performed by pulsed deposition. In an embodiment, in the step of forming the iridium oxide layer on the ruthenium (Ru) layer by the electrodeposition, the pulsed deposition may be performed at 0.4 V_{SCE} (2 sec), −0.65 V_{SCE} (10 sec) and 0 V_{SCE} (2 sec) for 30 cycles.

### Example

Hereinafter, the present disclosure will be described in detail by examples. However, the following examples are provided to help a full understanding of the present disclosure, and the present disclosure is not limited to the following examples.

### <Preparation Example 1> Manufacture of Oxidizing Electrode

1. Electrodeposition of Ruthenium (Ru) Layer

Ruthenium (III) chloride hydrate (99.9%, Alfa aesar) is added to a 0.25 M solution of perchloric acid (HClO₄) and stirred for 30 minutes to prepare a ruthenium (Ru) deposition solution. Before electrodeposition, a titanium paper (thickness 250 μm, porosity 60%, fiber diameter 20 μm, 2 PTL9N-025, Bekaert) to be used for a working electrode undergoes acid treatment in an oxalic acid solution (5 g/L) of 60° C. for 30 minutes. Subsequently, pulsed deposition is performed on the ruthenium (Ru) layer on the titanium paper at −500 mA (0.05 sec) and 200 mA (0.05 sec) for 120 cycles, and direct current deposition is performed by applying a predetermined voltage. A titanium mesh electrode and a saturated calomel electrode (SCE) are used as a counter electrode and a reference electrode, respectively. The direct current deposition voltage is adjusted to −2.5 V_{SCE}, −2 V_{SCE}, −1.5 V_{SCE} and −1 V_{SCE}. The direct current deposition time is adjusted to 1, 2, 5 and 10 minutes.

2. Electrodeposition of Iridium Oxide Layer

Iridium (IV) chloride hydrate (K₃IrCl₆) and sodium sulfate (Na₂SO₄) are added to deionized water, stirred for 30 minutes, and heated at 70° C. to prepare an iridium oxide (IrO₂) deposition solution. Subsequently, pulsed deposition of the iridium oxide layer on the ruthenium (Ru) layer is performed at 0.4 V_{SCE} (2 sec), −0.65 V_{SCE} (10 sec) and 0 V_{SCE} (2 sec) for 30 cycles to manufacture an oxidizing electrode (Ru@Ir). The oxidizing electrode manufacturing conditions are shown in the following Table 1.

TABLE 1

| | Direct current deposition | Direct current deposition |
|---|---|---|
| Classification | voltage (V_{SCE}) | time (min) |
| Example 1 | −2.5 | 1 |
| Example 2 | −2.5 | 2 |
| Example 3 | −2.5 | 5 |
| Example 4 | −2.5 | 10 |
| Example 5 | −2 | 2 |
| Example 6 | −1.5 | 2 |
| Example 7 | −1 | 2 |

### <Reference Example 1> Manufacture of Oxidizing Electrode of Comparative Example

An oxidizing electrode (Pt@Ir) of comparative example 1 is manufactured by the same method as example 2 except that a platinum (Pt) layer is formed instead of the ruthenium (Ru) layer. Additionally, comparative example 2 is prepared by the electrodeposition of only the iridium oxide layer without electrodeposition of the ruthenium (Ru) layer. An oxidizing electrode of comparative example 3 is manufactured by the same method as example 2 except that the spraying technique is used. Comparative examples 4 to 7 are prepared by the direct current deposition of only the ruthenium (Ru) layer for 1, 2, 5 and 10 minutes without electrodeposition of the iridium oxide layer.

### <Preparation Example 2> Manufacture of Reducing Electrode

Pt/C powder (Pt 46.5 weight %, Tanaka K. K) is added to deionized water, weight % Nafion™ solution and isopropanol, and ultrasound (40 kHz) is applied for 1 hour to prepare a slurry. The slurry is applied to Nafion™ 212 membrane by the catalyst-coated membrane (CCM) process to manufacture a reducing electrode having Pt/C coating of 0.2 mg/cm² on the membrane.

### <Preparation Example 3> Manufacture of Membrane Electrode Assembly (MEA)

The reducing electrode manufactured in preparation example 2, the Nafion™ 212 membrane (50 μm) or Nafion™ 115 membrane (125 μm) and the oxidizing electrode manufactured in preparation example 1 are stacked in a sequential order, and hot pressing is performed at 120° C. for 1 minute under the pressure of 2.7 Mpa. Subsequently, a cell is tightened to 80 lb·in to manufacture a MEA of sandwich structure (2.25 cm²).

### <Experimental Example 1> Observation 1 of Oxidizing Electrode Surface

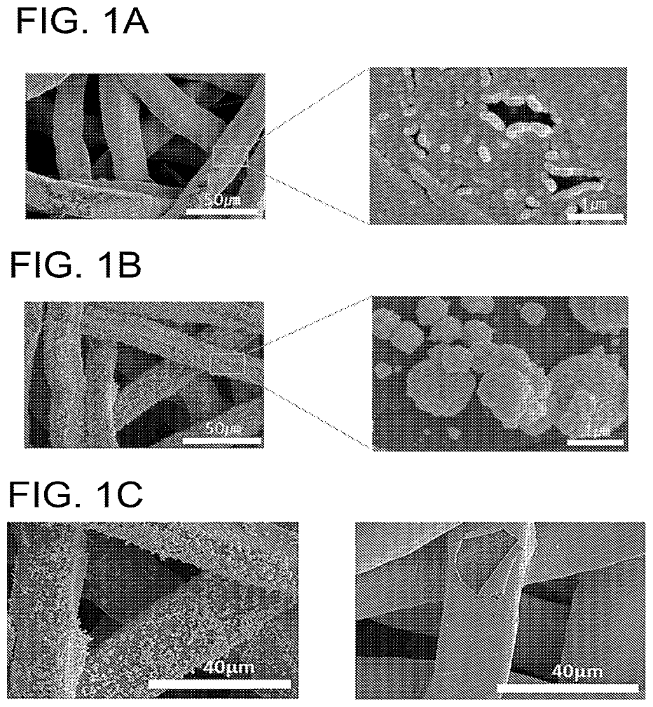

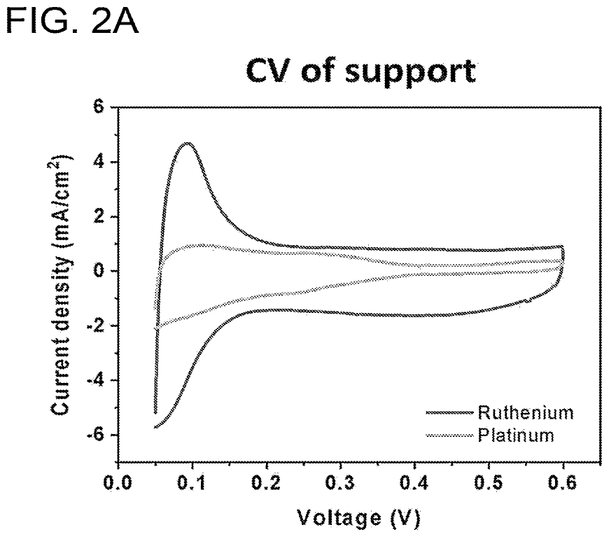

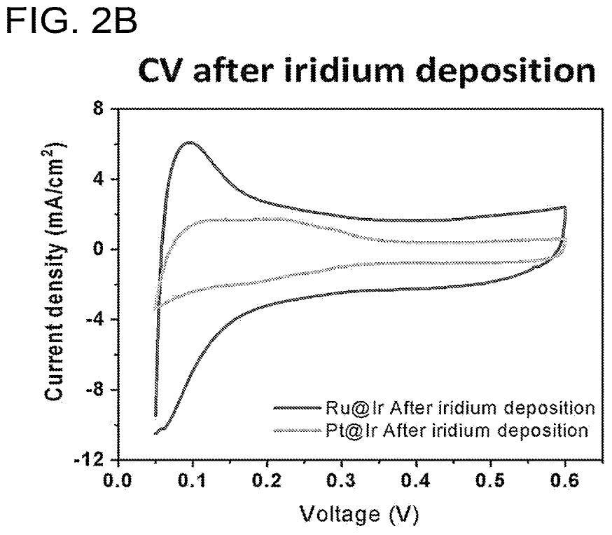

The shape and distribution of catalyst particles electrodeposited on the substrate is observed by Field Emission Scanning Electron Microscope (FE-SEM) (Teneo Volume Scope). The FE-SEM images are shown in FIGS. 1A to 1C. In FIGS. 1A and 1B, FIG. 1A, and FIG. 1B show example 2 (Ru@Ir) and comparative example 1 (Pt@Ir), respectively. In FIG. 1C, comparative example 1 (Pt@Ir) and example 2 (Ru@Ir) are shown on the left and right sides, respectively. It can be seen from FIG. 1A and FIG. 1B that the particle sizes of example 2 (Ru@Ir) and comparative example 1 (Pt@Ir) are different from each other. It can be seen from FIG. 1C that example 2 (Ru@Ir) (right drawing) shows faster bubble removal.

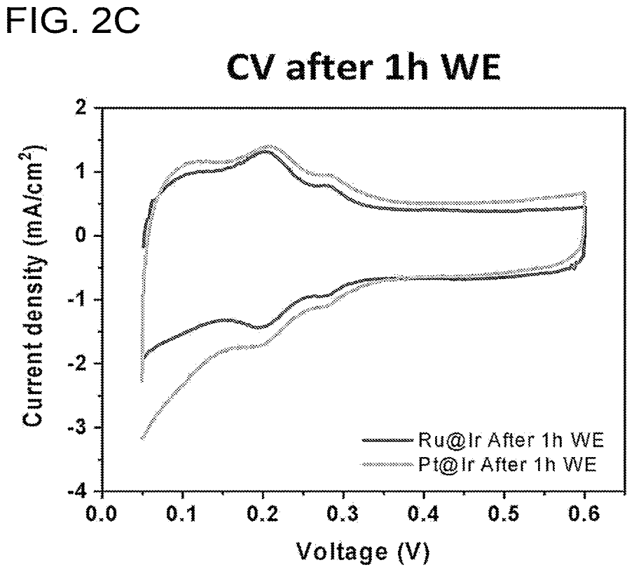

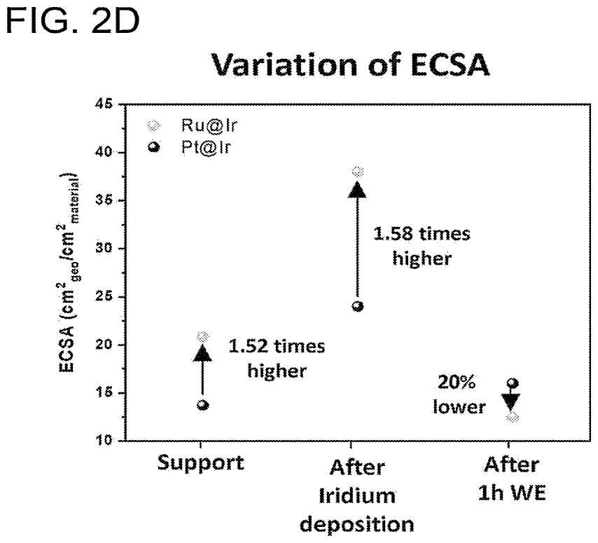

Meanwhile, a cyclic voltammetry (CV) curve is obtained to measure the electrochemically active surface area of the oxidizing electrode. A normalized electrochemical surface area (ECSA) is obtained from the mass activity from the CV curve. FIGS. 2A to 2C are graphs showing the CV curve of the oxidizing electrode according to an embodiment of the present disclosure. FIG. 2D is a graph showing the electrochemical surface area (ECSA) of the oxidizing electrode according to an embodiment of the present disclosure. It can be seen from FIG. 2D that the surface area of example 2 (Ru@Ir) is 1.58 times larger than the surface area of comparative example 1 (Pt@Ir). Additionally, it can be seen from FIG. 2C that due to the catalyst dissociation by water electrolysis (WE), example 2 (Ru@Ir) shows the similar surface area to comparative example 1 (Pt@Ir).

### <Experimental Example 2> Observation 2 of Oxidizing Electrode Surface

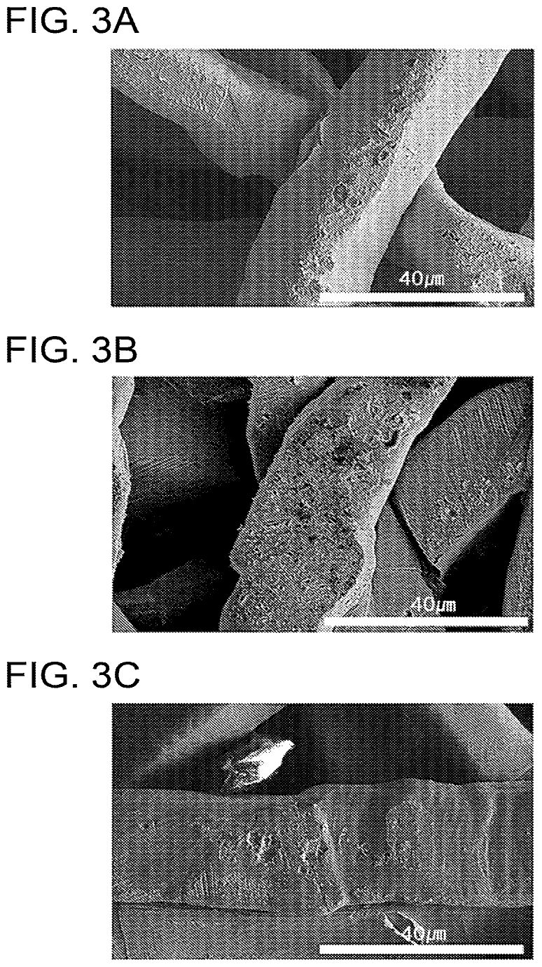

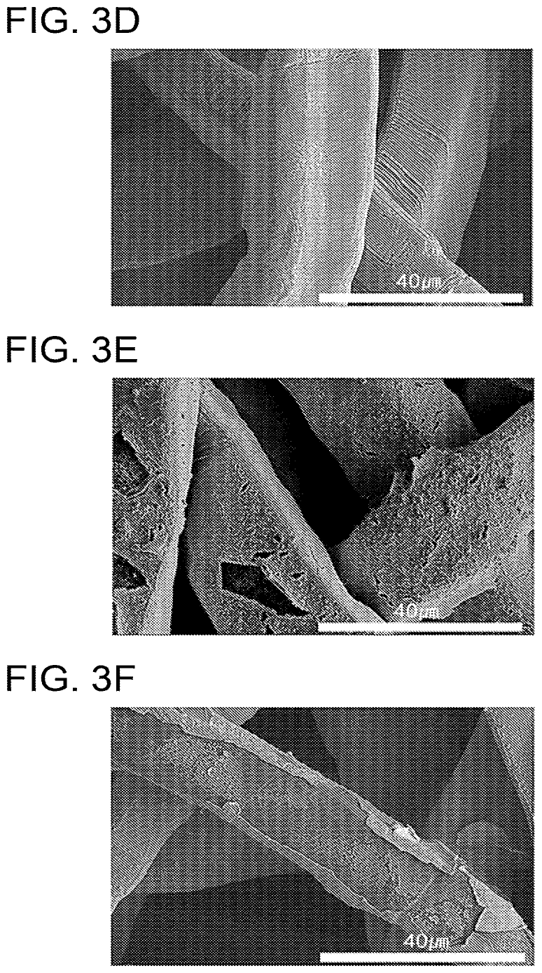

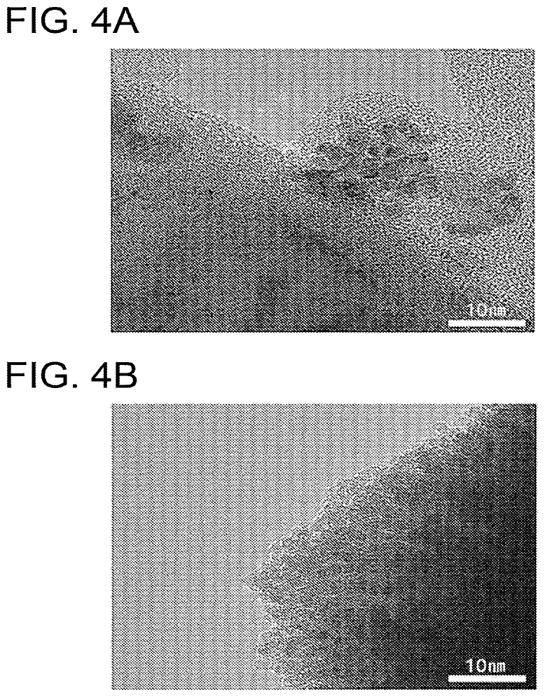

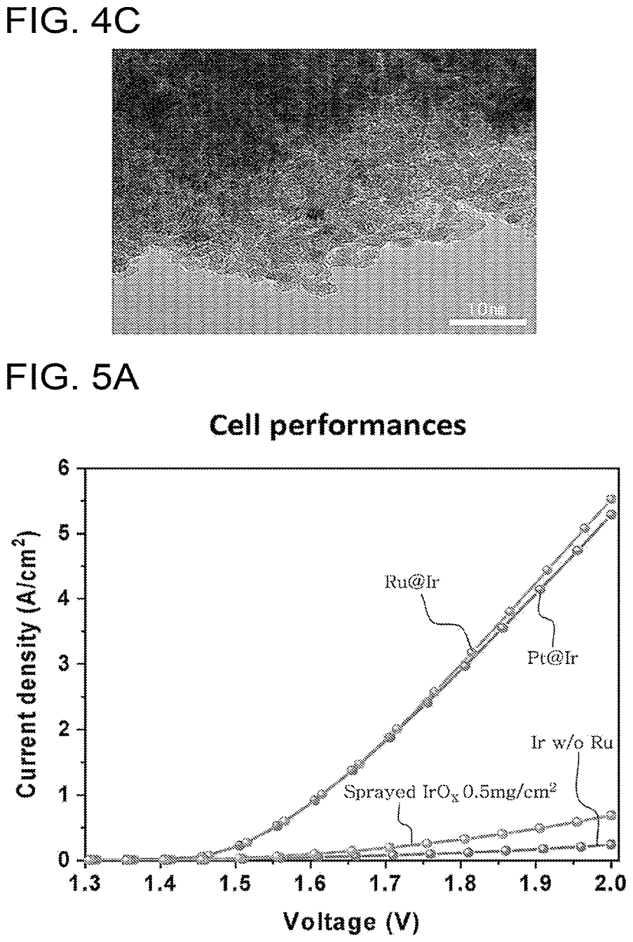

FIGS. 3A to 3F show images of examples 2 to 4 and comparative examples 5 to 7. In FIGS. 3A to 3C, FIG. 3A, FIG. 3B and FIG. 3C show comparative examples 5 to 7, respectively. FIG. 3D shows example 2, FIG. 3E shows example 3, and FIG. 3F shows example 4. The shape and distribution of catalyst particles electrodeposited on the substrate is observed by high resolution transmission electron microscope (HR-TEM, Talos). FIGS. 4A to 4C show the HR-TEM image. In FIGS. 4B and 4C, FIG. 4B and FIG. 4C show comparative examples 5 and 6, respectively. FIG. 4A shows example 2. It can be seen from FIGS. 3A to 3F that when the direct current deposition time of ruthenium (Ru) exceeds the preferred time, the bond strength between the substrate and the thick ruthenium (Ru) layer reduces, causing the ruthenium (Ru) layer to peel. Through this, it can be seen that the optimal direct current deposition time of ruthenium (Ru) can be derived.

### <Experimental Example 3> Analysis of Catalyst Composition

The catalyst composition is analyzed using Inductively Coupled Plasma Optical Emission Spectroscopy (ICP-OES) (iCAP6500 Duo, Thermo). The analysis results are shown in the following Table 2.

TABLE 2

| | Classification (mg/cm²) | | |
|---|---|---|---|
| | Ruthenium (Ru) | Iridium (Ir) | Sum (Ru + Ir) |
| Example 1 | 0.030991874 | 0.046851284 | 0.077843 |
| Example 2 | 0.044677112 | 0.060707643 | 0.105385 |
| Example 3 | 0.064805184 | 0.048246722 | 0.113052 |
| Example 4 | 0.113040403 | 0.066203101 | 0.179244 |
| Comparative | 0.037205612 | x | 0.037205612 |
| example 4 | | | |
| Comparative | 0.047090255 | x | 0.047090255 |
| example 5 | | | |
| Comparative | 0.076339689 | x | 0.076339689 |
| example 6 | | | |
| Comparative | 0.087789158 | x | 0.087789158 |
| example 7 | | | |

### <Experimental Example 4> Evaluation 1 of Water Electrolysis Performance

1. Evaluation Method

To evaluate the water electrolysis performance of the MEA manufactured in preparation example 3, an end plate, a carbon bipolar plate having a reducing electrode, the MEA, a titanium bipolar plate having an oxidizing electrode and an end plate are assembled in that order to manufacture a water electrolysis cell. For the oxidizing electrode, the oxidizing electrodes of example 2 (Ru@Ir), comparative example 1 (Pt@Ir), comparative example 2 and comparative example 3 are used.

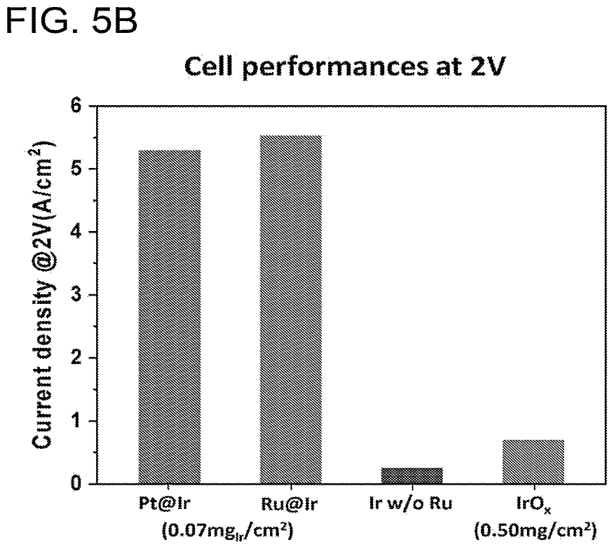

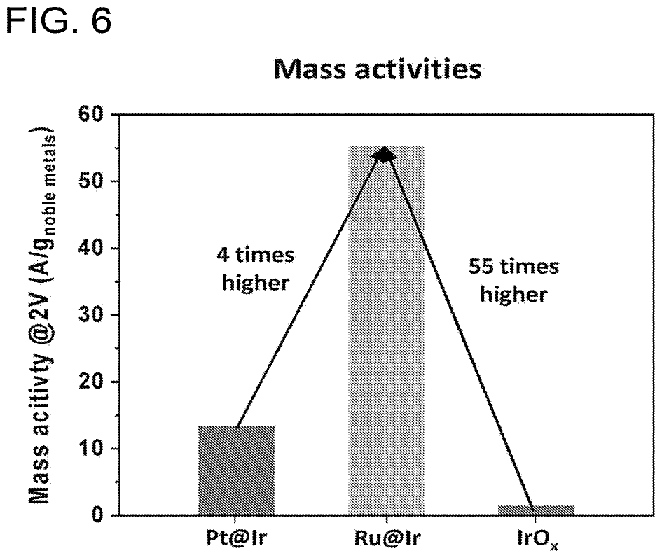

To carry out water electrolysis, the temperature of the cell is set to 80° C., and deionized water is fed into the oxidizing electrode at the flow rate of 15 mL/min. To prevent external gas from entering the reducing electrode, the entrance of gas passage is closed. The performance measurement is performed at each voltage for 1 minute with the increasing voltage from 1.25 V to 2.0 V by 0.5 V. The current-voltage relationship (IV-curve) is measured using a high current potentiostat (HCP-803, Bio-Logic). The current density measured at each voltage is recorded every 10 seconds, and the current density at each voltage is calculated by averaging the values. The current density is shown in FIGS. 5A and 5B. On the other hand, the mass activity is evaluated using ICP-OES. The mass activity is shown in FIG. 6.

2. Evaluation Results

It can be seen from FIGS. 5A and 5B that the performance of the water electrolysis cell using the oxidizing electrode of example 2 (Ru@Ir) is higher than the performance of the water electrolysis cell using the oxidizing electrode of comparative example 1 (Pt@Ir). It can be seen from FIGS. 5A and 5B that the performance of the water electrolysis cell using the oxidizing electrode of comparative example 2 not supported by ruthenium (Ru) is 96% lower than the performance of the water electrolysis cell using the oxidizing electrode of example 2 (Ru@Ir). Additionally, it can be seen from FIGS. 5A and 5B that the performance of the water electrolysis cell using the oxidizing electrode of example 2 (Ru@Ir) is 5 times higher than the performance of the water electrolysis cell using the commercially available oxidizing electrode using the spraying technique.

It can be seen from FIG. 6 that when considering that the amount of noble metals used in example 2 (Ru@Ir) is 25% of comparative example 1 (Pt@Ir), the mass activity of example 2 is 4 times higher than that of comparative example 1.

### <Experimental Example 5> Evaluation 2 of Water Electrolysis Performance

1. Evaluation Method

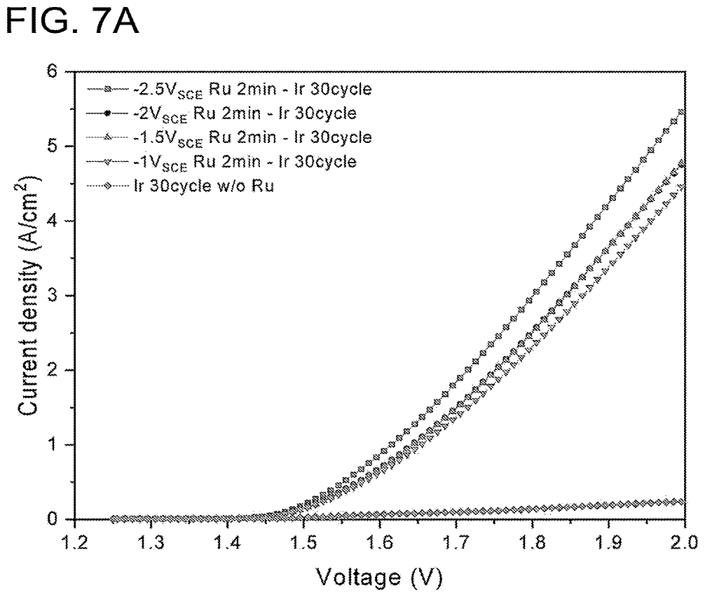

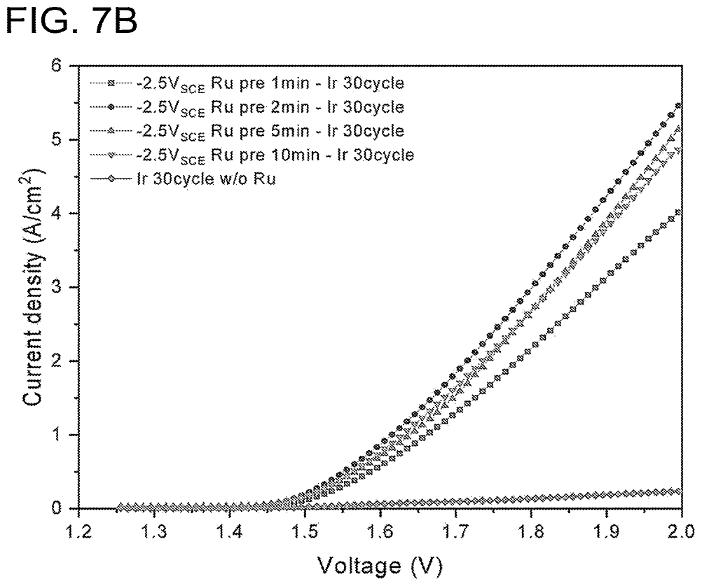

The water electrolysis performance of the MEA is evaluated by performing the same method as experimental example 4. FIGS. 7A and 7B are graphs showing an I-V polarization curve of the oxidizing electrode according to an embodiment of the present disclosure. FIG. 7A shows the current density when the oxidizing electrodes of examples 2, 5, 6 and 7 (Ru@Ir), and the oxidizing electrode of comparative example 2 not supported by ruthenium (Ru) are used. FIG. 7B shows the current density when the oxidizing electrodes of examples 1 to 4 (Ru@Ir) and the oxidizing electrode of comparative example 2 not supported by ruthenium (Ru) are used.

2. Evaluation Results

It can be seen from FIG. 7A that when the direct current deposition voltage of ruthenium (Ru) is −2.5 V_{SCE}, the water electrolysis performance is highest. It can be seen from FIG. 7B that in the case of example 2, the water electrolysis performance is highest. Through this, it can be seen that the direct current deposition voltage and time of ruthenium (Ru) for achieving the optimal performance of the water electrolysis device can be derived.

### <Experimental Example 6> Evaluation 1 of Durability of Oxidizing Electrode

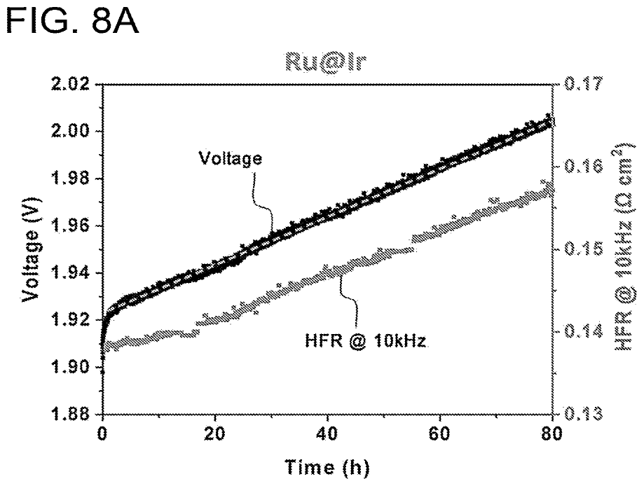

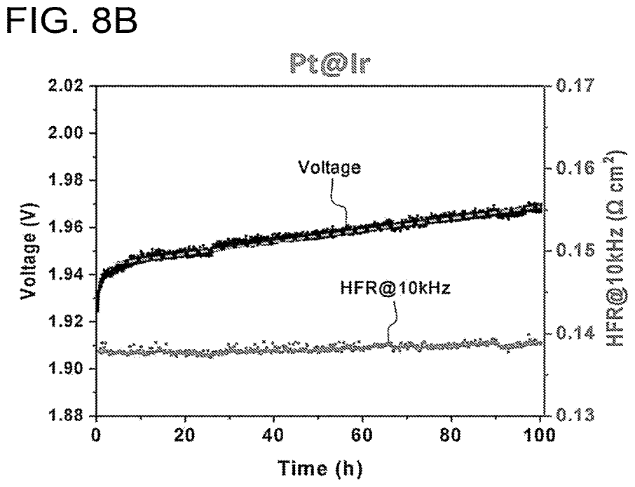

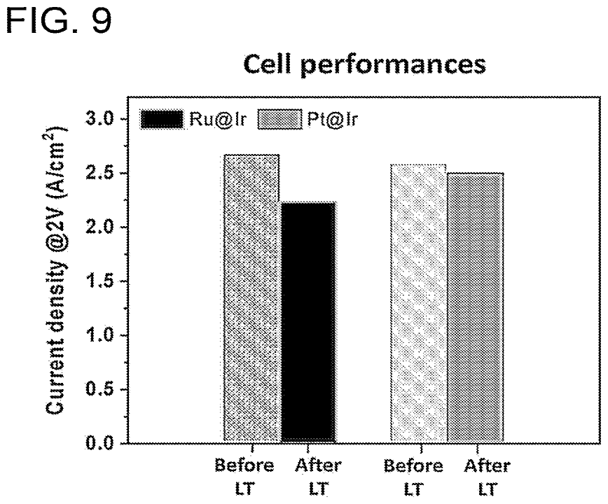

The stability evaluation is performed in 1 h long-term operation by applying the constant current density of 2 A/cm² to the water electrolysis cell. The results are shown in FIGS. 8A and 8B. The cell performance is shown in FIG. 9.

It can be seen from FIGS. 8A and 8B that in the long-term operation, the degradation rate (950 μV/h) of example 2 (Ru@Ir) is 4.1 times higher than the degradation rate (234 μV/h) of comparative example 1 (Pt@Ir). It can be seen from FIG. 9 that the reduced current density value (0.44 A/cm²) of example 2 (Ru@Ir) is 5.5 times higher than the value (0.08 A/cm²) of comparative example 1(Pt@Ir).

### <Experimental Example 7> Evaluation 2 of Durability of Oxidizing Electrode

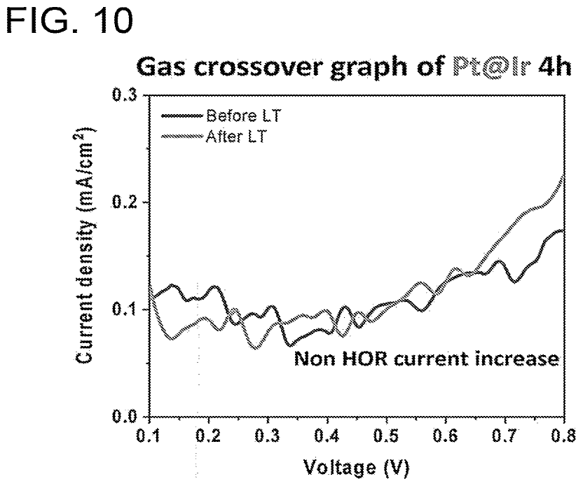

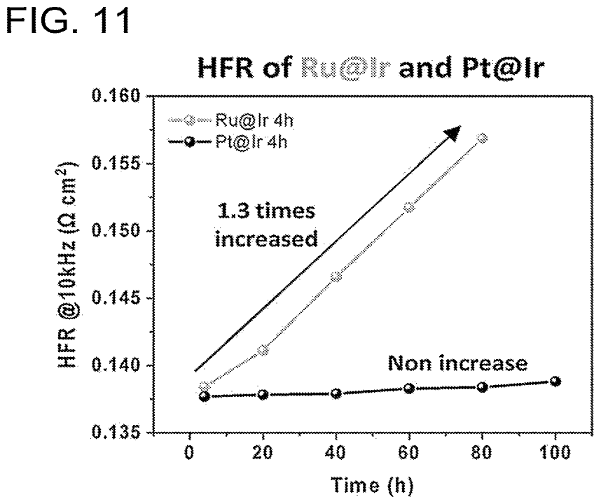

The stability evaluation is performed in 1 h long-term operation by applying the constant current density of 2 A/cm² to the water electrolysis cell. The results are shown in FIGS. 10 and 11. FIG. 10 is a graph showing an I-V polarization curve of the oxidizing electrode according to an embodiment of the present disclosure. FIG. 11 is a graph showing high-frequency resistance (HFR) of the oxidizing electrode according to an embodiment of the present disclosure.

It can be seen from FIG. 10 that comparative example 1 (Pt@Ir) does not increase in hydrogen oxidation reaction (HOR) current in the long-term operation, and it can be predicted that it results from non-thermal degradation of the membrane. Additionally, it can be seen from FIG. 11 that in the long-term operation, example 2 (Ru@Ir) has a 1.3-fold increase in HFR compared to comparative example 1 (Pt@Ir). It can be seen that comparative example 1 (Pt@Ir) does not increase in HFR, and it can be predicted that it results from non-titanium oxidation.

### <Experimental Example 8> XPS Analysis of Oxidizing Electrode

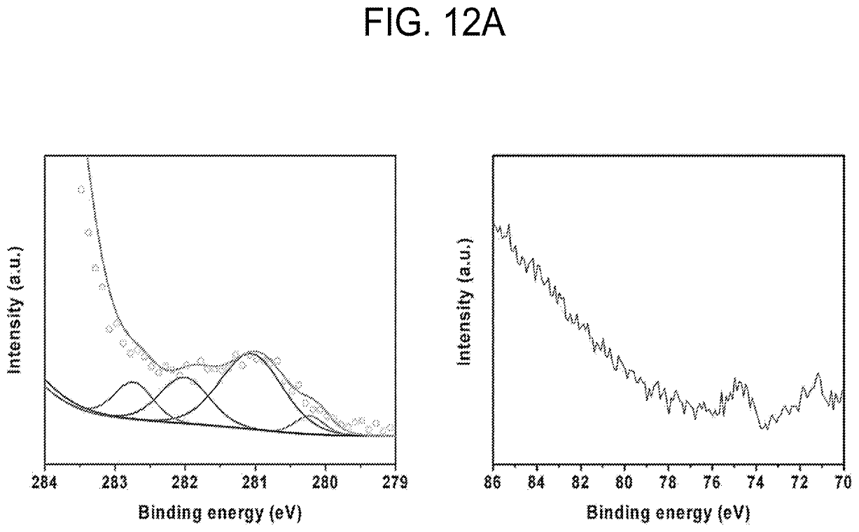

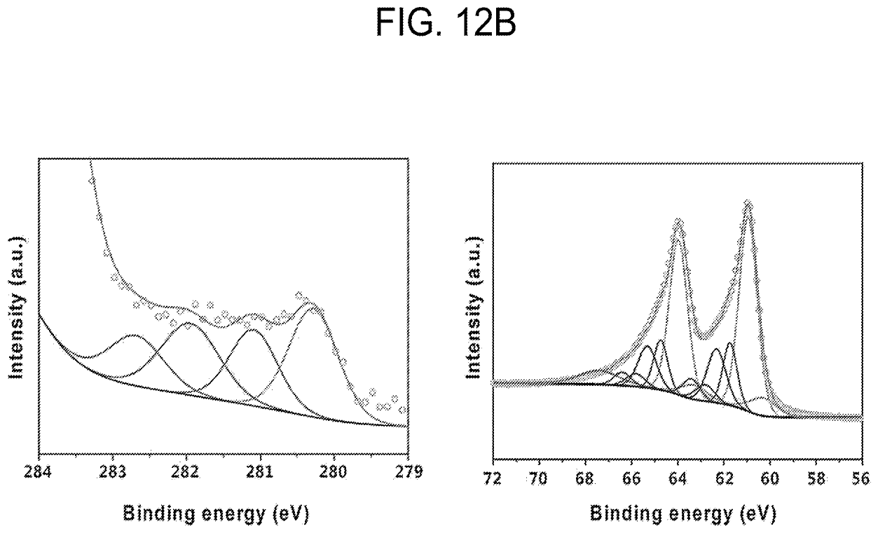

XPS analysis is performed on the oxidizing electrode of example 2 (Ru@Ir) and the oxidizing electrode of comparative example 1 (Pt@Ir) using X-Ray Photoelectron Spectroscopy (XPS) (Thermo VG Scientific, Germany) (Al Kα, 1486.6 eV). The results are shown in FIGS. 12A and 12B. FIGS. 12A and 12B are graphs showing the XPS analysis results of the oxidizing electrode according to an embodiment of the present disclosure.

It can be seen from FIG. 12A that ruthenium 3d peak is found in the oxidizing electrode of example 2 (Ru@Ir). It can be predicted that ruthenium is dissolved in the high voltage range of the oxygen evolution reaction (OER) to form ruthenium tetroxide (RuO₄). Platinum (Pt) 4f peak is not found in the oxidizing electrode of comparative example 1 (Pt@Ir).

It can be seen from FIG. 12B that the surface of the oxidizing electrode of example 2 (Ru@Ir) is covered with iridium oxide. Additionally, it can be seen from the right drawing in FIG. 12B that the electron configuration of iridium (Ir) is the same as the electron configuration of iridium oxide (IrO₂), and from the foregoing, it can be seen that the electrodeposition does not change the electron binding energy of iridium oxide (IrO₂).

### <Experimental Example 9> Evaluation of Mass Activity

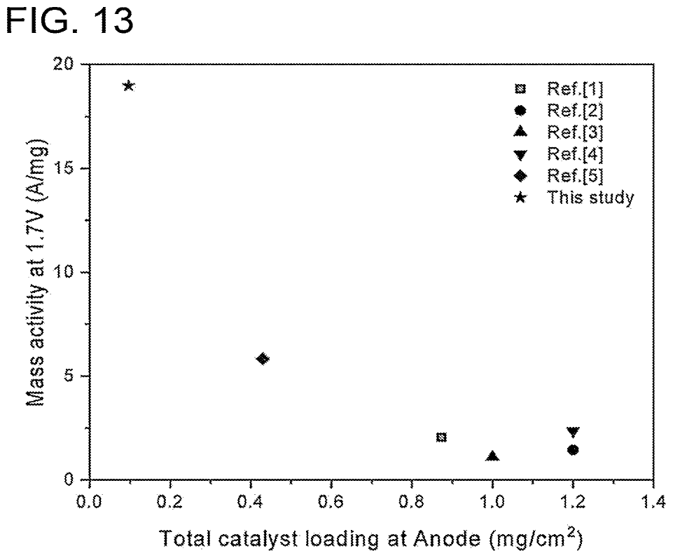

The mass activity of the oxidizing electrode of example 2 is evaluated. ICP-OES is used to evaluate the mass activity. The results are shown in FIG. 13.

It can be seen from FIG. 13 that compared to the earlier studies such as (Non-Patent Literature 0001) Journal of Power Sources 342. 947-955. 2017; (Non-Patent Literature 0002) Applied Catalysis B: Environmental 269. 118762. 2020; (Non-Patent Literature 0003) Chem. Sci. 6. 3321-3328. 2015; (Non-Patent Literature 0004) Nano Energy 88. 106276. 2021; (Non-Patent Literature 0005) Applied Catalysis B: Environmental 272. 118955. 2020, there is higher mass activity at lower catalyst loading. This can be explained by the increased improved surface area and the optimal distribution of catalyst particles.

### <Experimental Example 10> Evaluation of Durability and Performance According to Operation Method

1. Evaluation Method

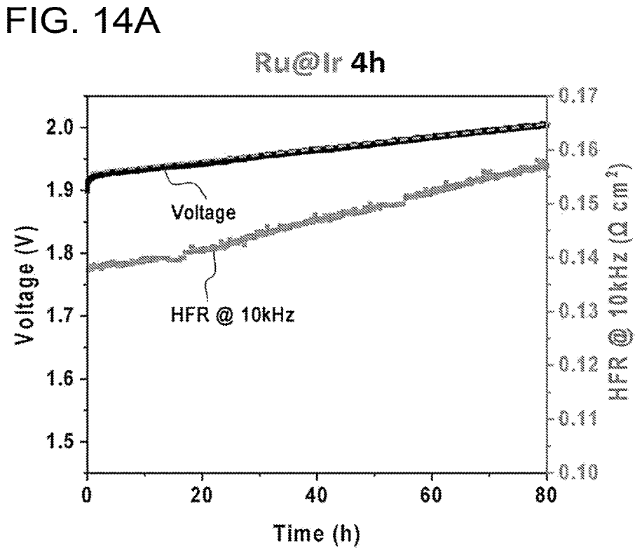

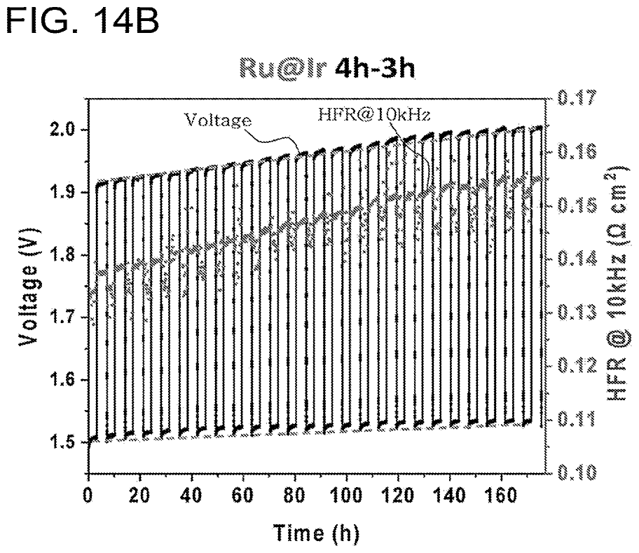

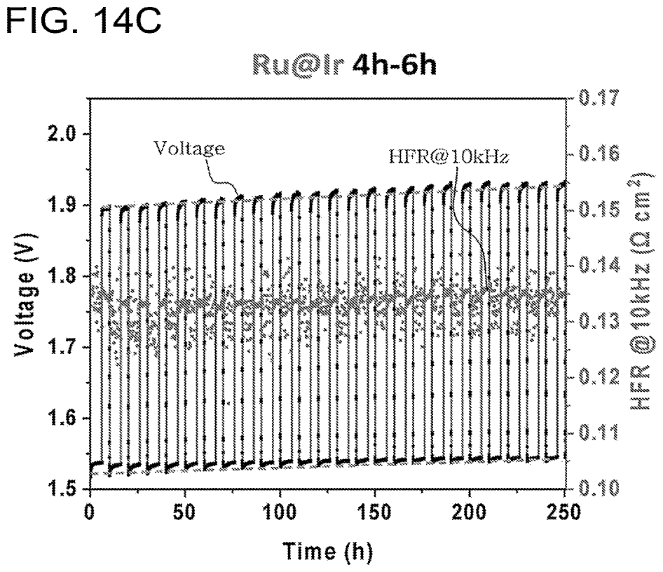

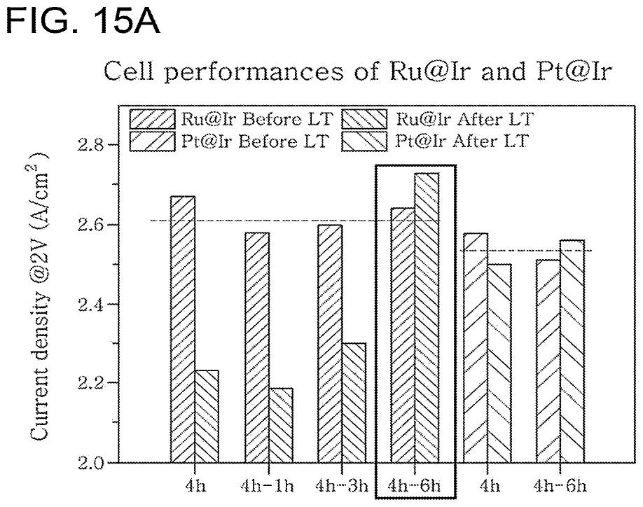

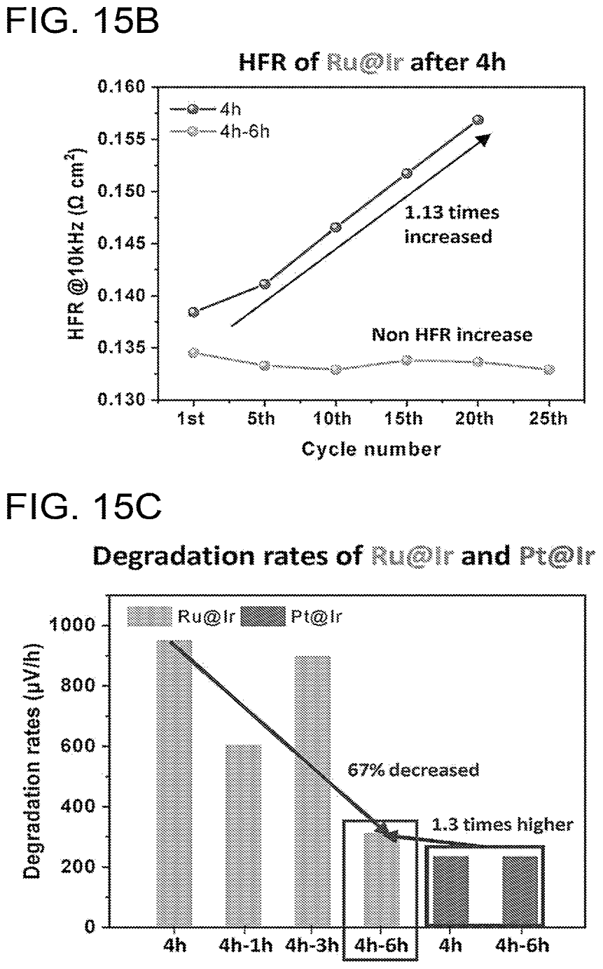

The stability evaluation is performed on the water electrolysis cell. The switch operation is performed by fixing the duration of application of high current density (2 A/cm²) to 4 hours, and in the meantime, applying low current density (0.1 A/cm²) for each of 0, 1, 3 and 6 hours. To set the high current operation time to 100 hours, each cycle repeats 25 times. The results are shown in FIGS. 14A to 14C. FIGS. 14A to 14C are graphs showing the durability evaluation results of the oxidizing electrode according to an embodiment of the present disclosure. The cell performance, HFR and degradation rate are shown in FIGS. 15A, 15B and 15C, respectively.

2. Evaluation Results

It can be seen from FIGS. 14A to 14C that the performance degradation rate and the degradation rate of the water electrolysis cell is decreased by the switch operation. More specifically, in the case of 4 h-6 h switch operation, the cell voltage and HFR does not increase. Additionally, it can be seen from FIG. 15A that in the case of 4 h-6 h switch operation, the cell performance improves. It can be seen from FIG. 15B that example 2 (Ru@Ir) has a 1.13-fold increase in HFR in the 4 h-6 h switch operation compared to the 4 h high current operation. It can be seen from FIG. 15C that the degradation rate has a 67% decrease compared to the 4 h high current operation and a 1.3-fold increase compared to the 4 h-6 h switch operation of comparative example 1 (Pt@Ir).

### <Experimental Example 11> Evaluation of Atomic Ratio of Oxidizing Electrode According to Operation Method

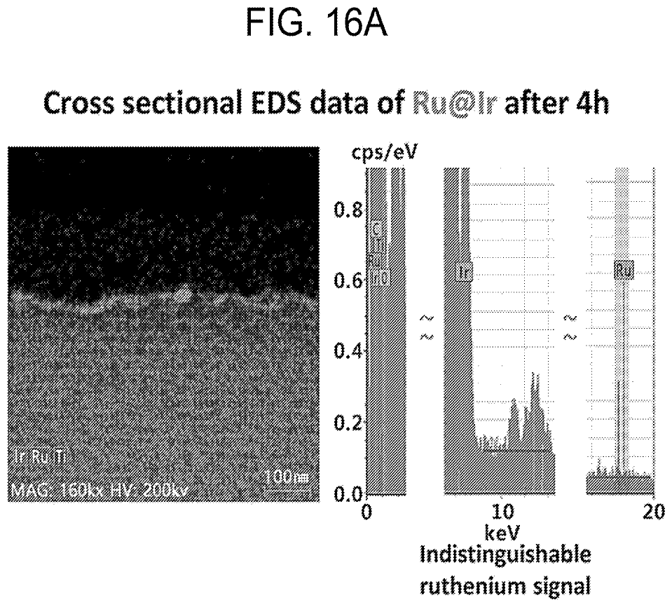

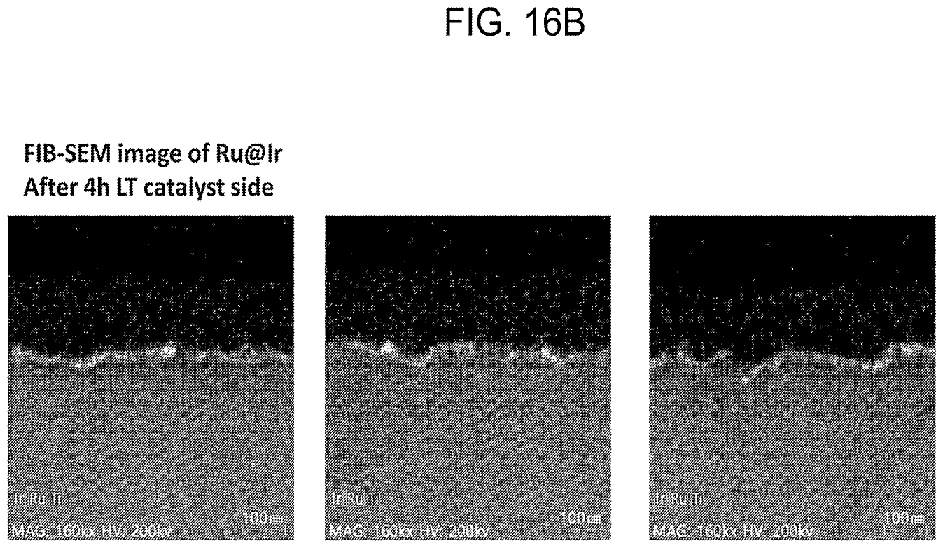

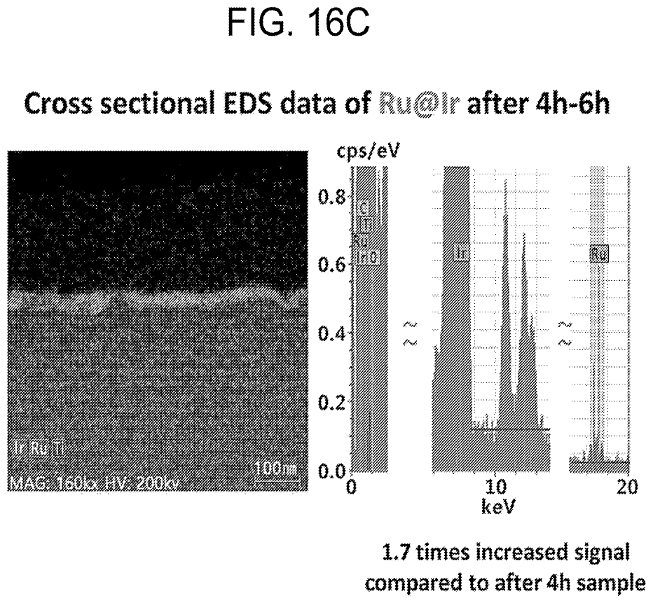

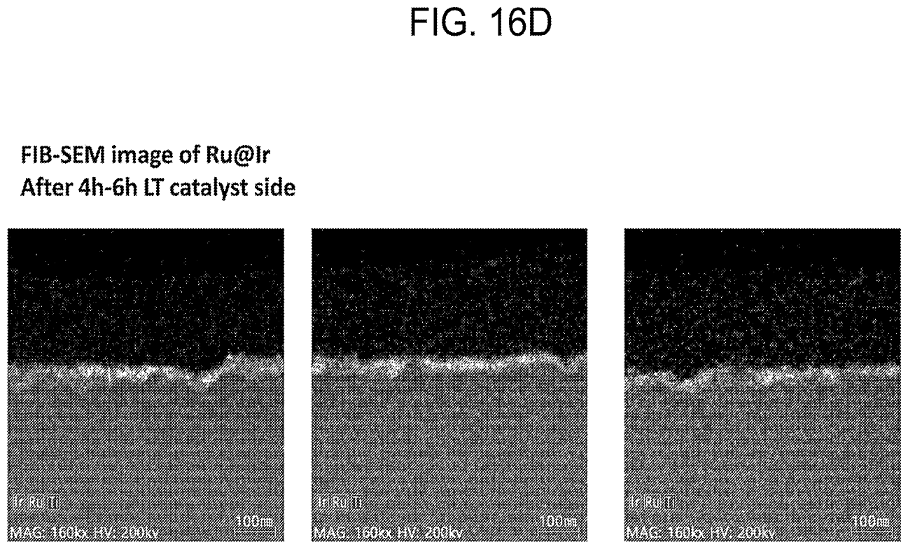

In the 4 h high current operation and the 4 h-6 h switch operation of the water electrolysis cell using the oxidizing electrode of example 2 (Ru@Ir), the atomic ratio is measured by Energy Dispersive X-ray Spectroscopy (EDS). The results are shown in FIGS. 16A to 16D.

It can be seen from FIGS. 16A to 16D that in the case of the 4 h-6 h switch operation, the detected signals are 1.7 times higher, and catalyst dissociation can be decreased by the 4 h-6 h switch operation.

### <Experimental Example 12> XPS Analysis of Oxidizing Electrode According to Operation Method

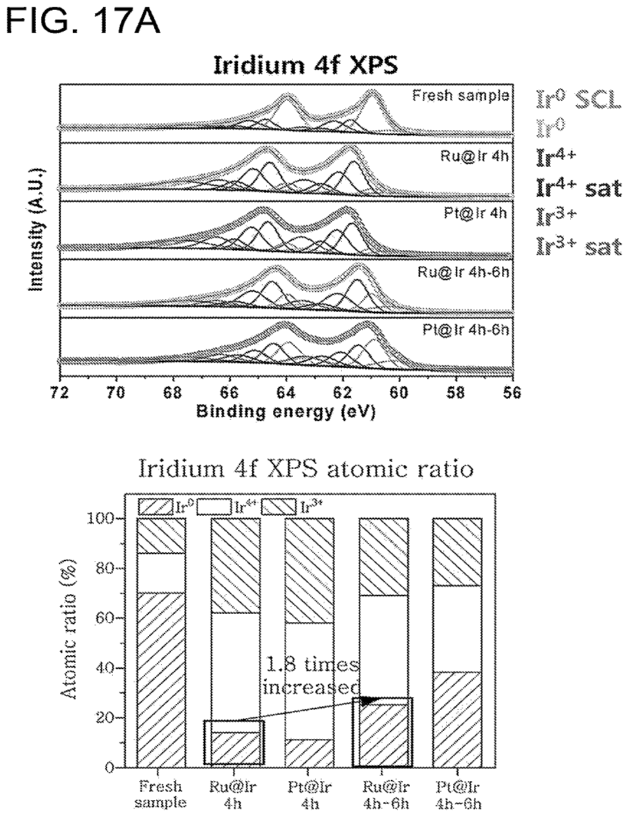

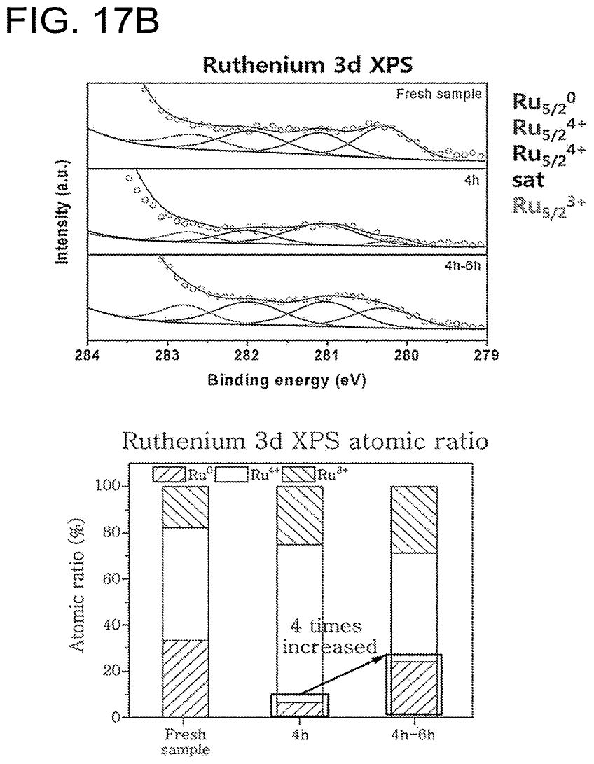

In the 4 h high current operation and the 4 h-6 h switch operation of the water electrolysis cell, XPS analysis is performed using X-ray photoelectron spectroscopy (XPS, Thermo VG Scientific, Germany) (Al Kα, 1486.6 eV). The results are shown in FIGS. 17A and 17B.

It can be seen from FIG. 17A that in the 4 h-6 h switch operation of the oxidizing electrode of example 2 (Ru@Ir) and the oxidizing electrode of comparative example 1 (Pt@Ir), the iridium binding energy is lower than that of the 4 h high current operation. It can be seen from FIG. 17B that there is the same tendency at ruthenium 3d peak. In the case of the 4 h-6 h switch operation, the amount of remaining catalysts is larger than that of the 4 h high current operation, and thus it is expected that overoxidation will be reduced.

### <Experimental Example 13> Observation of Oxidizing Electrode Surface According to Operation Method

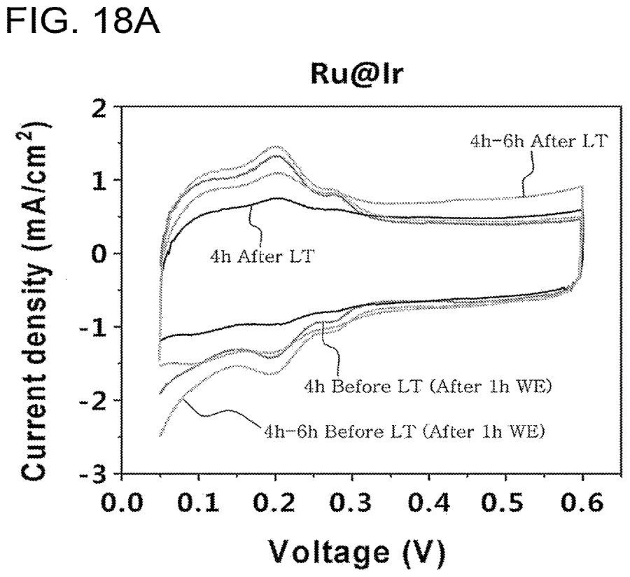

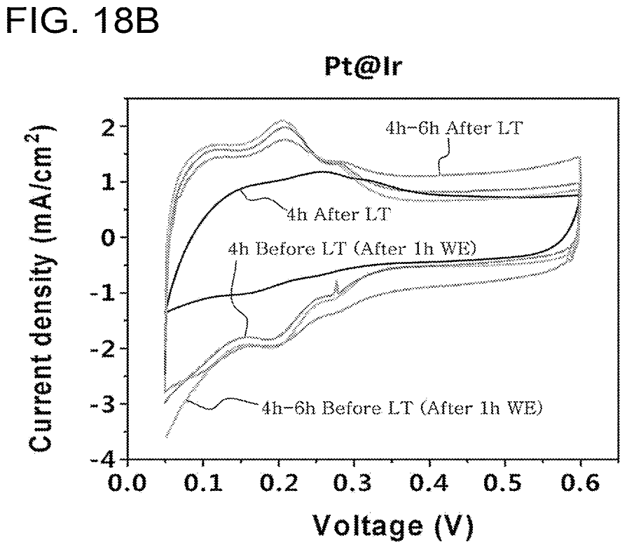

To measure the electrochemically active surface area of the oxidizing electrode according to the operation method, a CV curve is obtained. The switch operation is performed by fixing the duration of application of high current density (2 A/cm²) to 4 hours, and in the meantime, applying low current density (0.1 A/cm²) for 6 hours. FIGS. 18A and 18B are graphs showing the CV curve of the oxidizing electrode according to an embodiment of the present disclosure.

It can be seen from FIGS. 18A and 18B that the surface area of example 2 (Ru@Ir) is larger than the surface area of comparative example 1 (Pt@Ir). Additionally, the surface area when the 1 h long-term operation is performed before the switch operation is larger than the surface area when the long-term operation is not performed.

While exemplary embodiments of the present disclosure have been hereinabove described with regard to the above-mentioned embodiments, various modifications or changes may be made thereto without departing from the spirit or scope of the present disclosure. Accordingly, such modifications or changes within the spirit of the present disclosure will be included in the appended claims.

1. An oxidizing electrode, comprising:
a substrate;
a ruthenium (Ru) layer formed on the substrate by electrodeposition; and
an iridium oxide layer formed on the ruthenium (Ru) layer by the electrodeposition.

2. The oxidizing electrode according to claim 1, wherein the ruthenium (Ru) layer is deposited in a form of a film, and a thickness of the film is 140 to 154 nm.

3. The oxidizing electrode according to claim 1, wherein a thickness of the iridium oxide layer is 140 to 160 nm.

4. The oxidizing electrode according to claim 1, wherein a specific surface area of the iridium oxide layer is 11 to 12 m²/g.

5. The oxidizing electrode according to claim 1, wherein a weight of the ruthenium (Ru) layer per unit area of the oxidizing electrode is 0.01 to 0.06 mg/cm².

6. The oxidizing electrode according to claim 1, wherein a total weight of the ruthenium (Ru) layer and the iridium oxide layer per unit area of the oxidizing electrode is 0.05 to 0.11 mg/cm².

7. The oxidizing electrode according to claim 1, wherein the substrate is a titanium paper made of titanium fibers.

8. A water electrolysis device comprising the oxidizing electrode according to claim 1.

9. A water electrolysis device comprising the oxidizing electrode according to claim 2.

10. A water electrolysis device comprising the oxidizing electrode according to claim 3.

11. A water electrolysis device comprising the oxidizing electrode according to claim 4.

12. A water electrolysis device comprising the oxidizing electrode according to claim 5.

13. A water electrolysis device comprising the oxidizing electrode according to claim 6.

14. A water electrolysis device comprising the oxidizing electrode according to claim 7.
